(19) United States
(12) Patent Application Publication
(10) Pub. No.: US 2014/0307060 A1
(43) Pub. Date: Oct. 16, 2014

(54) IMAGE SENSOR

(71) Applicant: NIKON CORPORATION, Tokyo (JP)

(72) Inventors: Kiyoshige SHIBAZAKI, Higashimurayama-shi (JP); Muneki HAMASHIMA, Fukaya-shi (JP); Susumu MORI, Tokyo (JP)

(21) Appl. No.: 14/256,417

(22) Filed: Apr. 18, 2014

Related U.S. Application Data
(63) Continuation of application No. PCT/JP2012/005189, filed on Aug. 17, 2012.

(30) Foreign Application Priority Data
Oct. 21, 2011 (JP) 2011-231490

(51) Int. Cl. H04N 13/02

(52) U.S. Cl. CPC H04N 13/0217
USPC 348/49

(57) ABSTRACT

There is a problem that fluxes of light to pass through a peripheral region of the pupil do not reach a peripheral region of an image capturing element due to vignetting. Provided is an image capturing element provided two-dimensionally and cyclically with photoelectric converting element groups each consisting of plural photoelectric converting elements for converting incident light to electric signals, wherein apertures of aperture masks provided correspondingly for the plural photoelectric converting elements included in each photoelectric converting element group are positioned to let through fluxes of light from different partial regions in a cross-sectional region of incident light, the number of photoelectric converting elements included in each photoelectric converting element group is smaller in a photoelectric converting element group arranged in a peripheral region of an entire region in which the photoelectric converting element groups are arranged than in a photoelectric converting element group arranged in a center region.

The contents of the following Japanese and PCT patent applications are incorporated herein by reference:

NO. 2011-231490 filed on Oct. 21, 2011, and

NO. PCT/JP2012/005189 filed on Aug. 17, 2012.

### BACKGROUND

1. Technical Field

The present invention relates to an image capturing element.

2. Related Art

A stereo image capturing apparatus is known which captures stereo images consisting of an image for a right eye and an image for a left eye by using two image capturing optical systems. Such a stereo image capturing apparatus produces a parallax between two images captured from the same object by disposing two image capturing optical systems at a predetermined interval.

### CONVENTIONAL ART DOCUMENT

### Patent Document

[Patent Document 1] Japanese Patent Application Publication No. H8-47001

### SUMMARY

It is virtually possible to ignore the influence of vignetting, when capturing a plurality of parallax images with different image capturing systems respectively. However, when there is only one image capturing system, an image capturing element outputs image signals for generating a plurality of parallax images by one exposure operation, which entails a problem of vignetting in which fluxes of light that pass through the peripheral region of the pupil might not reach the peripheral region of the image capturing element.

An image capturing element according to a specific embodiment of the present invention includes photoelectric converting element groups arranged two-dimensionally and cyclically and each including a plurality of photoelectric converting elements that photoelectrically convert incident light to electric signals, wherein apertures of aperture masks provided in correspondence with the plurality of photoelectric converting elements included in each of the photoelectric converting element groups are positioned so as to let through fluxes of light from different partial regions included in a cross-sectional region of the incident light, and the number of the plurality of photoelectric converting elements included in each of the photoelectric converting element groups is smaller in such photoelectric converting element groups that are arranged in a peripheral region of an entire region in which the photoelectric converting element groups are arranged than in such photoelectric converting element groups that are arranged in a center region of the entire region.

The summary clause does not necessarily describe all necessary features of the embodiments of the present invention. The present invention may also be a sub-combination of the features described above.

### BRIEF DESCRIPTION OF THE DRAWINGS

FIG. 1 is a diagram explaining a configuration of a digital camera according to an embodiment of the present invention.

FIG. 2A is a schematic diagram showing a cross-section of an image capturing element according to an embodiment of the present invention.

FIG. 2B is a schematic diagram showing a cross-section of an image processing element according to an embodiment of the present invention.

FIG. 3 is a schematic diagram showing an enlarged view of a portion of an image capturing element.

FIG. 4A is a concept diagram explaining a relationship between parallax pixels in a center region of an image capturing element and an object.

FIG. 4B is a concept diagram explaining a relationship between parallax pixels in a center region of an image capturing element and an object.

FIG. 5 is a concept diagram explaining a relationship between parallax pixels in a peripheral region of an image capturing element and an object.

FIG. 6 is a diagram explaining repetition patterns in respective regions of an image capturing element.

FIG. 7 is a concept diagram explaining a process for generating parallax images.

FIG. 8A is a diagram showing another example of a repetition pattern.

FIG. 8B is a diagram showing another example of a repetition pattern

FIG. 8C is a diagram showing another example of a repetition pattern.

FIG. 9A is a diagram showing yet another example of a repetition pattern.

FIG. 9B is a diagram showing yet another example of a repetition pattern.

FIG. 9C is a diagram showing yet another example of a repetition pattern.

FIG. 10 is a diagram explaining repetition patterns in respective regions of an image capturing element for outputting vertical parallax pixels.

FIG. 11 is a diagram explaining a color filter arrangement.

FIG. 12 is a diagram showing a relationship between a color filter arrangement and parallax pixels.

FIG. 13 is a concept diagram showing processes of generating parallax pixels and a 2D image.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

A digital camera according the present embodiment, which is one form of an image capturing apparatus, can generate images of one scene from a plurality of viewpoints by one image capturing operation. The images captured from different viewpoints from each other will be referred to as parallax images.

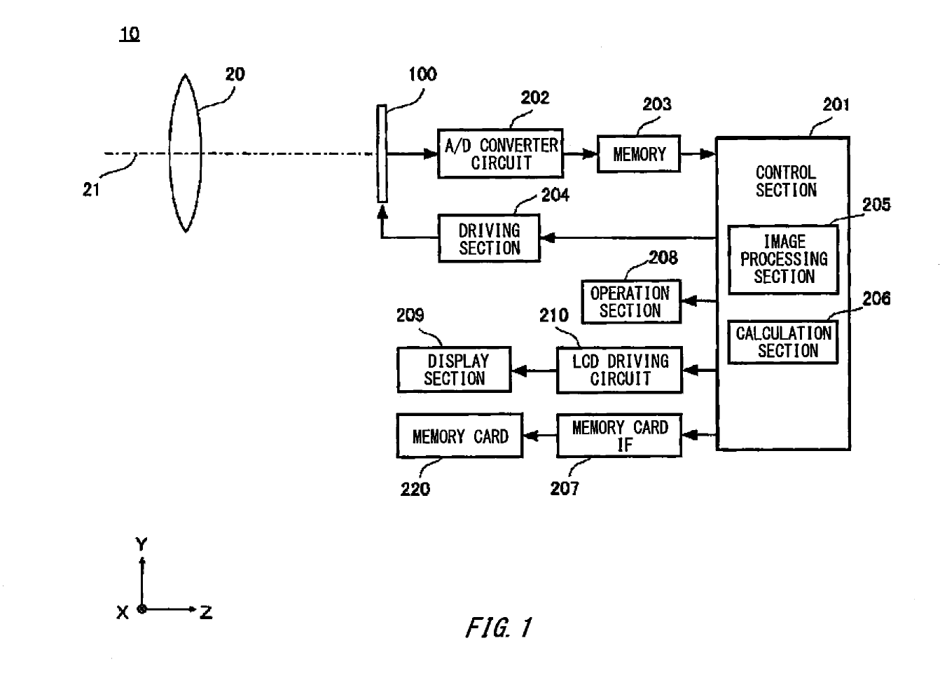

FIG. 1 is a diagram explaining the configuration of a digital camera 10 according to an embodiment of the present invention. The digital camera 10 includes an image capturing lens 20 as an image capturing optical system, which guides an incident flux of light from an object into an image capturing element 100 along an optical axis 21. The image capturing lens 20 may be a replaceable lens that is detachable from the digital camera 10. The digital camera 10 includes the image capturing element 100, a control section 201, an A/D converter circuit 202, a memory 203, a driving section 204, a memory card IF 207, an operation section 208, a display section 209, and an LCD driving circuit 210.

As shown in the drawing, a direction parallel with the optical axis 21 heading for the image capturing element 100 is defined as +Z axis direction, a direction coming out from the sheet within a plane perpendicular to the Z axis is defined as +X axis direction, and a direction going upward in the sheet is defined as +Y axis direction. In relation to the image composition, the X axis is the horizontal direction and the Y axis is the vertical direction. In some of the drawings to be described below, the coordinate axes will be drawn to enable the directions of the drawing to be taken hold of based on the coordinate axes of FIG. 1.

The image capturing lens 20 includes a plurality of optical lenses, and forms an image of a flux of light from an object in a scene on about a focal plane thereof. For the expediency of explanation, the image capturing lens 20 is shown in FIG. 1 represented by one virtual lens positioned at about a pupil. The image capturing element 100 is positioned at about the focal plane of the image capturing lens 20. The image capturing element 100 is an image sensor such as a CCD, a CMOS sensor, etc. on which a plurality of photoelectric converting elements are arranged two-dimensionally. Under the timing control of the driving section 204, the image capturing element 100 converts an object image formed on its light receiving plane to an image signal and outputs it to the A/D converter circuit 202.

The A/D converter circuit 202 converts the image signal output from the image capturing element 100 to a digital image signal and outputs it to the memory 203. An image processing section 205, which constitutes a part of the control section 201, generates image data by carrying out various image processes using the memory 203 as a work space. For example, when generating image data of a JPEG file format, the image processing section 205 compresses the image data after applying a white balance process, a gamma process, etc. The generated image data is converted to a display signal by the LCD driving circuit 210 and displayed on the display section 209. The generated image data is also recorded on a memory card 220 attached into the memory card IF 207.

A series of image capturing sequence is started when the operation section 208 receives an operation from a user and outputs an operation signal to the control section 201. Operations such as AF, AE, etc. involved in the image capturing sequence are executed under the control of a calculation section 206.

The digital camera 10 provides a normal image capturing mode, and in addition, a parallax image capturing mode. The user can select any of the modes by operating the operation section 208 while viewing the display section on which a menu window is displayed.

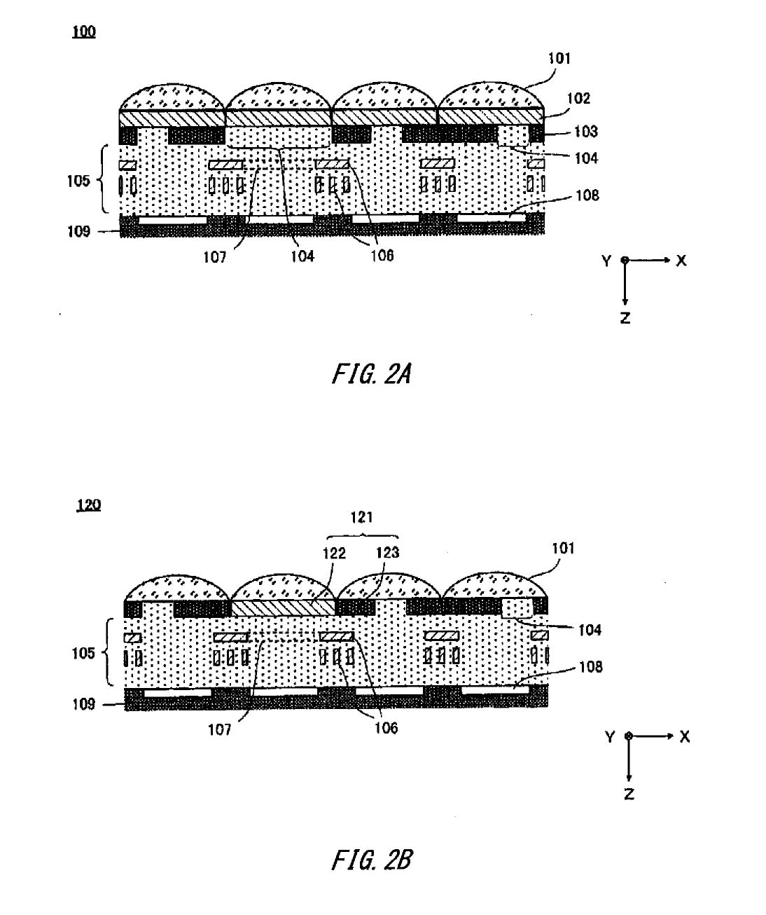

Next, the configuration of the image capturing element 100 will be explained in detail. FIG. 2 are schematic diagrams showing cross-sections of the image capturing element according to the present embodiment. FIG. 2A is a schematic diagram showing a cross-section of the image capturing element 100 in which color filters 102 and aperture masks 103 are separate components. FIG. 2B is a schematic diagram showing a cross-section of a modified example of the image capturing element 100, i.e., an image capturing element 120 including a screen filter 121 in which color filter sections 122 and aperture mask sections 123 are integrated.

As shown in FIG. 2A, the image capturing element 100 includes from the object side in order, micro-lenses 101, color filters 102, aperture masks 103, an interconnection layer 105, and photoelectric converting elements 108. The photoelectric converting elements 108 are constituted by photodiodes for converting incident light to an electric signal. A plurality of photoelectric converting elements 108 are arranged two-dimensionally on the surface of a substrate 109.

An image signal resulting from the conversion by the photoelectric converting elements 108, a control signal for controlling the photoelectric converting elements 108, etc. are sent and received through interconnection lines 106 provided in the interconnection layer 105. The aperture masks 103 having apertures 104 provided in one-to-one correspondence to the plurality of photoelectric converting elements 108 are provided in contact with the interconnection layer. As will be described later, the apertures 104 are staggered with respect to their corresponding photoelectric converting elements 108 to have strictly-defined relative positions. As will be described in detail later, the aperture masks 103 having these apertures 104 act to produce a parallax in a flux of light from an object to be received by the photoelectric converting elements 108.

On the other hand, a photoelectric converting element 108 for which to produce no parallax has no aperture mask 103 provided thereon. In other words, it can be said that a photoelectric converting element 108 for which to produce no parallax has an aperture mask 103 provided thereon that has an aperture 104 that does not restrict a flux of light from an object to be incident to its corresponding photoelectric converting element 108, i.e., an aperture 104 that allows passage of all fluxes of effective light. The interconnection lines 106, which produce no parallax, can be considered aperture masks that allow passage of all fluxes of effective light in which to product no parallax, because apertures 107 resulting from the formation of the interconnection lines 106 substantially define an incident flux of light from an object. The aperture masks 103 may be arranged individually for the respective photoelectric converting element 108, or may be formed simultaneously for the plurality of photoelectric converting elements 108 like the manufacturing process of the color filters 102.

The color filters 102 are provided on the aperture masks 103. The color filters 102 are filters provided in one-to-one correspondence to the photoelectric converting elements 108 and colored so as to allow a specific wavelength band to transmit to the corresponding photoelectric converting elements 108. In order to output a color image, it is necessary to arrange at least three kinds of color filters different from one another. These color filters can be said to be primary color filters for generating a color image. The combination of primary color filters may include, for example, a red filter that allows a red wavelength band to transmit, a green filter that allows a green wavelength band to transmit, and a blue filter that allows a blue wavelength band to transmit. As will be described later, these color filters are arranged in a lattice formation to match the photoelectric converting elements 108. The combination of color filters may not only be a combination of the primary colors RGB but also be a combination of complementary colors YeCyMg.

The micro-lenses 101 are provided on the color filters 102. The micro-lenses 101 are condensing lenses that guide as much as possible of an incident flux of light from an object to the photoelectric converting elements 108. The micro-lenses 101 are provided in one-to-one correspondence to the photoelectric converting elements 108. It is preferred that in consideration of the relative positional relationship between the center of the pupil of the image capturing lens 20 and the photoelectric converting elements 108, the optical axes of the micro-lenses 101 be staggered such that as much as possible of a flux of light from an object is guided to the photoelectric converting elements 108. Furthermore, the positions of the micro-lenses 101 may be adjusted together with the positions of the apertures 104 of the aperture masks 103 such that as much as possible of a specific flux of light from an object to be described later is incident.

One unit of an aperture mask 103, a color filter 102, and a micro-lens 101 provided in one-to-one correspondence to each photoelectric converting element 108 is referred to as a pixel. Particularly, a pixel including an aperture mask 103 to produce a parallax is referred to as a parallax pixel, and a pixel including no aperture mask 103 to produce a parallax is referred to as a non-parallax pixel. For example, when the effective pixel region of the image capturing element 100 is about 24 min×16 mm, the number of pixels is about 12,000,000.

No micro-lenses 101 need to be provided for an image sensor having a good condensing efficiency and a good photoelectric converting efficiency. If the image sensor is a back-side illumination type, the interconnection layer 105 is provided on the opposite side to the photoelectric converting elements 108.

The combination of the color filters 102 and the aperture masks 103 includes many variations. If a color component is provided in the apertures 104 of the aperture masks 103 in FIG. 2A, the color filters 102 and the aperture masks 103 can be formed integrally. When a specific pixel is designated as a pixel to acquire luminance information of an object, this pixel needs to have no corresponding color filter 102. Alternatively, such a pixel may have a non-color transparent filter in order to allow substantially all wavelength bands of the visible light to transmit.

When a pixel to acquire luminance information is a parallax pixel, i.e., when parallax images are output as monochrome images at least once, the configuration of an image capturing element 120 shown in FIG. 2B can be employed. That is, a screen filter 121 in which color filter sections 122 functioning as color filters and aperture mask sections 123 having apertures 104 are formed integrally may be provided between the micro-lenses 101 and the interconnection layer 105.

The screen filter 121 is formed such that the color filter sections 122 are colored in, for example, blue, green, and red, and the aperture mask sections 123 are colored in black at the mask sections other than the apertures 104. The image capturing element 120 employing the screen filter 121 has a shorter distance from the micro-lenses 101 to the photoelectric converting elements 108 than in the image capturing element 100, and hence has a higher condensing efficiency for a flux of light from an object.

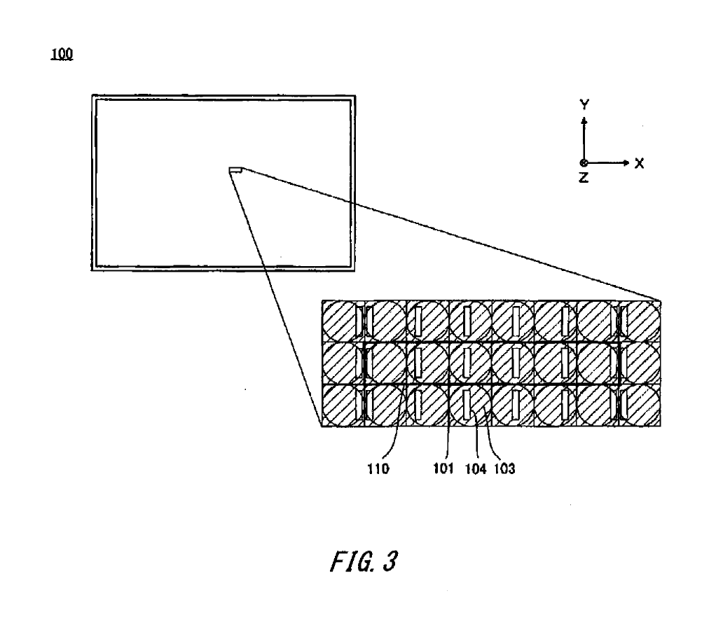

Next, the relationship between the apertures 104 of the aperture masks 103 and parallaxes to be produced will be explained. FIG. 3 is a schematic diagram showing an enlarged view of a portion of the image capturing element 100. To simplify the explanation, no consideration will be given to the coloring of the color filters 102, until reference to them is resumed later. Without the color filters 102, the image capturing element 100, which will function as a monochrome image sensor, can generate monochrome parallax images. In the following explanation where no reference is made to the coloring of the color filter 102, the image sensor can be considered an array of only such parallax pixels that have the color filters 102 of the same color. Therefore, the repetition pattern to be explained below may be considered adjoining pixels having the color filters 102 of the same color.

As shown in FIG. 3, the apertures 104 of the aperture masks 103 are staggered with respect to the corresponding pixels. Further, the apertures 104 in adjoining pixels are staggered with respect to each other.

In the shown example, there are six kinds of aperture masks 103 in which the positions of the apertures 104 with respect to the corresponding pixels are staggered in the X axis direction. On the whole, the image capturing element 100 is provided two-dimensionally and cyclically with photoelectric converting element groups each including six parallax pixels having the apertures 104 that are gradually staggered from the −X side to the +X side. That is, it can be said that the image capturing element 100 is composed being filled with repetition patterns 110 which are arranged cyclically and continuously and each include one photoelectric converting element group. In the shown example, the shape of the apertures 104 is a vertically-long rectangle, but is not limited to this. The apertures may have any shape, as long as the apertures are staggered with respect to the center of the corresponding pixels to have a line of sight that is directed to a specific partial region of the pupil.

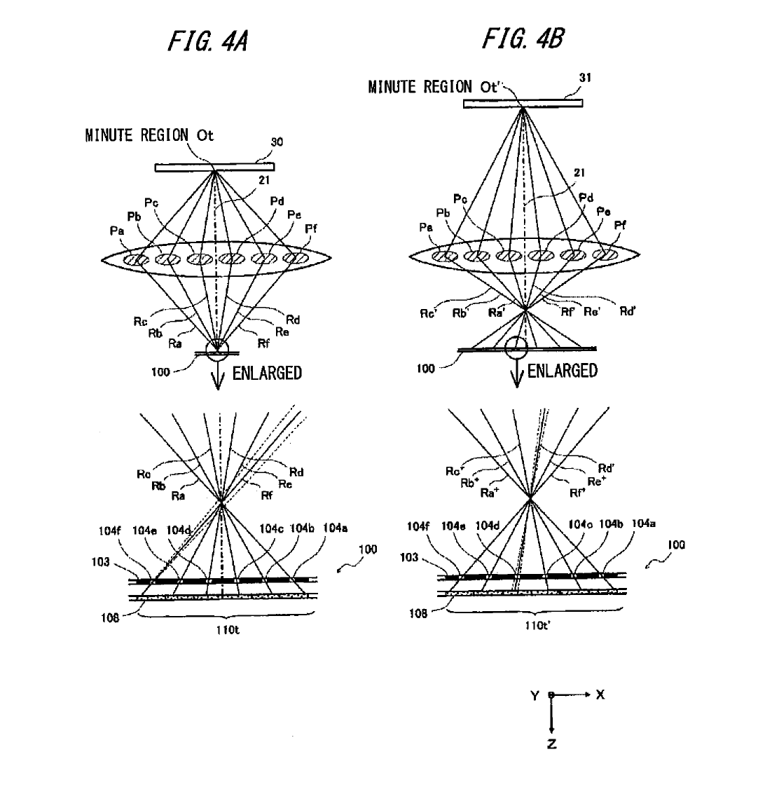

FIG. 4 are concept diagrams explaining the relationship between parallax pixels provided in the center region of the image capturing element 100 and an object. Particularly, FIG. 4A exemplarily shows a situation where the photoelectric converting element group of a repetition pattern 110t, which is arranged in the center of the image capturing element 100 perpendicular to the image capturing optical axis 21, captures an object 30 that is located at an in-focus position with respect to the image capturing lens 20. FIG. 4B exemplarily shows a situation where the same photoelectric converting element group as in FIG. 4A captures an object 31 that is located at an out-of-focus position with respect to the image capturing lens 20.

First, the relationship between the parallax pixels and the object will be explained as for the case where the image capturing element 100 captures the object 30 located at the in-focus position. A flux of light from the object is guided to the image capturing element 100 through the pupil of the image capturing lens 20 where six partial regions Pa to Pf are defined on the entire plane of a cross-sectional region to be passed through by the flux of light from the object. For example, as can be understood from the enlarged view, at the pixel at the −X-side end of the photoelectric converting element group constituting the repetition pattern 110t, the position of the aperture 104f of the aperture mask 103 is defined so as to allow only a flux of light from the object emitted from the partial region Pf to reach the photoelectric converting element 108. Likewise, toward the pixel at the +X-side end, the position of the aperture 104e is defined to match the partial region Pe, the position of the aperture 104d is defined to match the partial region Pd, the position of the aperture 104c is defined to match the partial region Pc, the position of the aperture 104b is defined to match the partial region Pb, and the position of the aperture 104a is defined to match the partial region Pa, respectively.

In other words, it is possible to say that, for example, the position of the aperture 104f is defined by the slope of a principal ray of light Rf of the flux of light from the object emitted from the partial region Pf, where the slope is defined by the relative positional relationship between the partial region Pf and the pixel at the −X-side end. When a flux of light from the object 30 located at the in-focus position is received by the photoelectric converting element 108 through the aperture 104f, the image of the flux of light from the object is formed on the photoelectric converting element 108 as shown by the dotted lines. Likewise, toward the pixel at the +X side end, the position of the aperture 104e is defined by the slope of a principal ray of light Re, the position of the aperture 104d is defined by the slope of a principal ray of light Rd, the position of the aperture 104c is defined by the slope of a principal ray of light Rc, the position of the aperture 104b is defined by the slope of a principal ray of light Rb, and the position of the aperture 104a is defined by the slope of a principal ray of light Ra, respectively.

As shown in FIG. 4A, a flux of light emitted from a minute region Ot of the in-focus object 30 crossing the optical axis 21 passes through the pupil of the image capturing lens 20 and reaches the respective pixels in the photoelectric converting element group constituting the repetition pattern 110t. That is, the pixels in the photoelectric converting element group constituting the repetition pattern 110t receive fluxes of light emitted from one minute region Ot through the six partial regions Pa to Pf, respectively. The minute region Ot has an area that can absorb any positional misalignment of the pixels in the photoelectric converting element group constituting the repetition pattern 110t, but can be substantially approximated by an object point having substantially the same size.

Next, the relationship between the parallax pixels and an object will be explained as for the case where the image capturing lens 20 captures the object 31 located at the out-of-focus position. Also in this case, a flux of light from the object 31 located at the out-of-focus position passes through the six partial regions Pa to Pf of the pupil of the image capturing lens 20 and reaches the image capturing element 100. However, the image of the flux of light from the object 31 located at the out-of-focus position is formed not on the photoelectric converting elements 108 but on another position. For example, as shown in FIG. 4B, when the object 31 is located at a position farther from the image capturing element 100 than is the object 30, the image of the flux of light from the object is formed at the object 31 side of the photoelectric converting elements 108. Conversely, when the object 31 is located at a position nearer the image capturing element 100 than is the object 30, the image of the flux of light from the object is formed at the side of the photoelectric converting elements 108 opposite to the object 31.

Therefore, a flux of light emitted from a minute region Ot′ of the out-of-focus object 31 passes through any of the six partial regions Pa to Pf, and depending of the partial regions passed, reaches corresponding pixels in different repetition patterns 110. For example, as shown in the enlarged view of FIG. 4B, a flux of light from the object passed through the partial region Pd, i.e., a principal ray of light Rd′ enters the photoelectric converting element 108 included in a repetition pattern 110t′ and corresponding to the aperture 104d. A flux of light passed through another partial region, even though it has been emitted from the minute region Ot′, does not enter the photoelectric converting element 108 included in the repetition pattern 110t′, but enters the photoelectric converting element 108 included in another repetition pattern and corresponding to the aperture corresponding to the passed partial region. In other words, fluxes of light from the object to reach the respective photoelectric converting elements 108 constituting the repetition pattern 110t′ are fluxes of light emitted from different minute regions of the object 31. That is, a flux of light from the object including the principal ray of light Rd′ enters the photoelectric converting element 108 corresponding to the aperture 104d, and fluxes of light from the object including principal rays of light Ra⁺, Rb⁺, Rc⁺, Re⁺, and Rf⁺ enter the photoelectric converting elements 108 corresponding to other apertures, and they are fluxes of light emitted from different minute regions of the object 31.

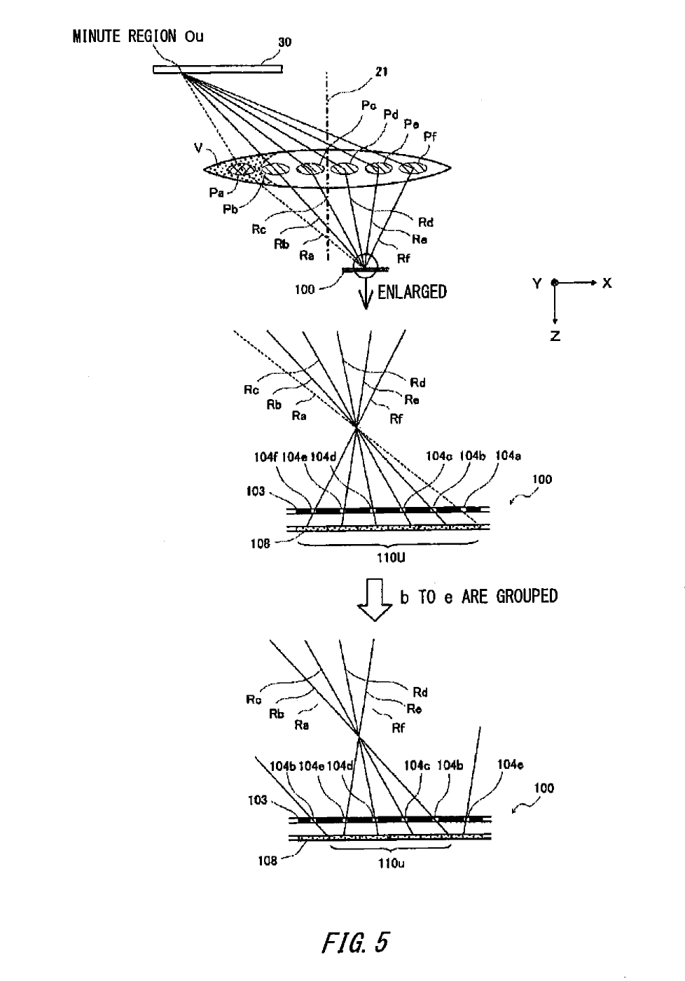

FIG. 5 is a concept diagram explaining the relationship between parallax pixels in the peripheral region of the image capturing element 100 and an object. The object 30 shown in FIG. 5 is located at an in-focus position with respect to the image capturing lens 20 like in FIG. 4A. Here, if there is no influence of vignetting to be described later, fluxes of light emitted from a minute region Ou of the in-focus object 30 that is off the optical axis 21 pass through the pupil of the image capturing lens 20 and reach the respective pixels in a photoelectric converting element group constituting a repetition pattern 110U. That is, the pixels included in the photoelectric converting element group constituting the repetition pattern 110U receive fluxes of light emitted from one minute region Ou through the six partial regions Pa to Pf, respectively. Like the minute region Ot, the minute region Ou also has an area that can absorb any positional misalignment of the pixels in the photoelectric converting element group constituting the repetition pattern 110U, but can be substantially approximated by an object point having substantially the same size.

That is, where the object 30 is at the in-focus position, the minute regions to be captured by the photoelectric converting element groups vary according to the positions of the repetition patterns 110 on the image capturing element 100, and the same minute region is captured through different partial regions by the respective pixels constituting each photoelectric converting element group. Further, the corresponding pixels in different repetition patterns 110 receive fluxes of light from the object through the same partial region. For example, the pixels at the −X-side end of the repetition patterns 110t and 110U (the parallax pixels corresponding to the apertures 104f) receive fluxes of light from the object through the same partial region Pf.

Strictly speaking, the position of the aperture 104f from which the pixel at the −X-side end of the repetition pattern 110t arranged in the center and perpendicular to the image capturing optical axis 21 receives a flux of light from the object through the partial region Pf is different from the position of the aperture 104f from which the pixel at the −X-side end of the repetition pattern 110U arranged in the peripheral region receives a flux of light from the object through the partial region Pf. However, from a functional viewpoint, they can be considered the aperture masks of the same kind because they are aperture masks for receiving fluxes of light from the object through the partial region Pf. Therefore, it is possible to say that the parallax pixels included in the repetition patterns 110t and 110U each include one of the six kinds of aperture masks.

When the image capturing element 100 is taken on the whole, an object image A captured by the photoelectric converting element 108 corresponding to the aperture 104a and an object image D captured by the photoelectric converting element 108 corresponding to the aperture 104d will have no image gap as long as they are images of the object located at the in-focus position, but will have image gap if they are images of the object located at the out-of-focus position. The direction and amount of the image gap are determined depending on to which side of the in-focus position and by how much the out-of-focus object is lopsided and on the distance between the partial region Pa and the partial region Pd. That is, the object image A and the object image D are images having a parallax between them. This relationship is also true for the other apertures, and six images having parallaxes are therefore generated correspondingly to the apertures 104a to 104f.

Hence, a parallax image is obtained when outputs from corresponding pixels in the respective repetition patterns 110 having the configuration described above are gathered. That is, a parallax image is formed by the outputs from pixels having received fluxes of light from the object that have been emitted through a specific partial region of the six partial regions Pa to Pf.

Some fluxes of light that pass through a specific partial region defined on the pupil of the image capturing lens 20 at a position far from the optical axis of the image capturing lens 20 do not intentionally reach the peripheral region of the image capturing element 100, but are shielded by a lens barrel frame, etc. that support the image capturing lens 20. That is, the partial region defined in the peripheral region of the pupil is influenced by so-called vignetting. In the case of the minute region Ou of FIG. 5 that is located on the minus side in the X axis direction, a flux of light from the object emitted from the minute region Ou is shielded in a peripheral region V of the pupil indicated by halftone dots due to vignetting.

As a result, a flux of light from the object including a principal ray of light Ra, which should originally pass through the partial region Pa included in the peripheral region V, will not actually reach the parallax pixel having the aperture 104a. A similar relationship is present when the minute region Ou is located at a symmetric position with respect to the optical axis 21 in the drawing. That is, when the minute region Ou is located at the plus side in the X axis direction, the peripheral region V includes the partial region Pf. In this case, a flux of light from the object including a principal ray of light Rf, which should originally pass through the partial region Pf, will not reach the parallax pixel having the aperture 104f, which is located in the peripheral region of the image capturing element 100 at the minus side in the X axis direction.

That is, a flux of light to be incident to the image capturing lens 20 from a peripheral region of an object field will not reach a parallax pixel having the aperture 104a or the aperture 104f in the peripheral region of the image capturing element 100. Hence, in the present embodiment, the repetition pattern 110 in the peripheral region of the image capturing element 100 is configured as a repetition pattern 110u consisting of parallax pixels having the apertures 104b to 104e as shown in the drawing. In other words, the repetition pattern 110t consisting of six parallax pixels is used in the center region, whereas the repetition pattern 110u consisting of four parallax pixels other than those on both sides is used in the peripheral region. Then, as shown in the lower diagram of FIG. 5, the repetition pattern 110u is arranged cyclically in the peripheral region of the image capturing element 100.

The degree of influence of vignetting is dependent on the position at which the partial region is located on the pupil of the image capturing lens 20 and the position at which the parallax pixel having the aperture to let through a flux of light from that partial region into the image capturing element 100 is located, etc. Specifically, since a given position is more likely to be in the shadow of vignetting as the position is farther from the center region of the image capturing element 100, a flux of light from the object is less likely to reach a parallax pixel having a slightly-staggered aperture, as that parallax pixel is located more deeply into the peripheral region.

Hence, in the image capturing element 100 according to the present embodiment, the number of parallax pixels constituting the repetition pattern 110 arranged in the peripheral region is lower than the number of parallax pixels constituting the repetition pattern 110 arranged in the center region. That is, as a given repetition pattern 110 is arranged more deeply into the center region of the image capturing element 100, the repetition pattern is more likely to include also such parallax pixels having largely-staggered apertures 104 having lines of sight that are directed to partial regions defined in the peripheral region of the pupil, while as a given repetition pattern 110 is arranged more deeply into the peripheral region of the image capturing element 100, the repetition pattern is more likely to include only such parallax pixels having slightly-staggered apertures 104 having lines of sight that are directed to partial regions defined deeply into the center region of the pupil. Since a repetition pattern 110 arranged in the center region includes also parallax pixels having slightly-staggered apertures 104 having lines of sight directed to partial regions defined deeply into the center region of the pupil, the number of parallax pixels included in that repetition pattern is larger than the number of parallax pixels included in a repetition pattern arranged in the peripheral region. For example, the number of parallax pixels included in the repetition pattern 110 is gradually reduced from the center to the periphery, like six parallax pixels in a repetition pattern arranged in the center region, four parallax pixels in a repetition pattern arranged in a peripheral region adjoining the center region, and two parallax pixels in a repetition pattern arranged in a more outward peripheral region. Here, the direction in which the center region of the image capturing element 100 is joined to a peripheral region is parallel with the direction in which the apertures 104 of the aperture masks 103 are staggered (i.e., the X axis direction in the drawing). That is, the image capturing element 100 is sectioned into a plurality of regions in the direction perpendicular to the direction in which the apertures 104 are staggered. A specific explanation will be given below with reference to the drawings.

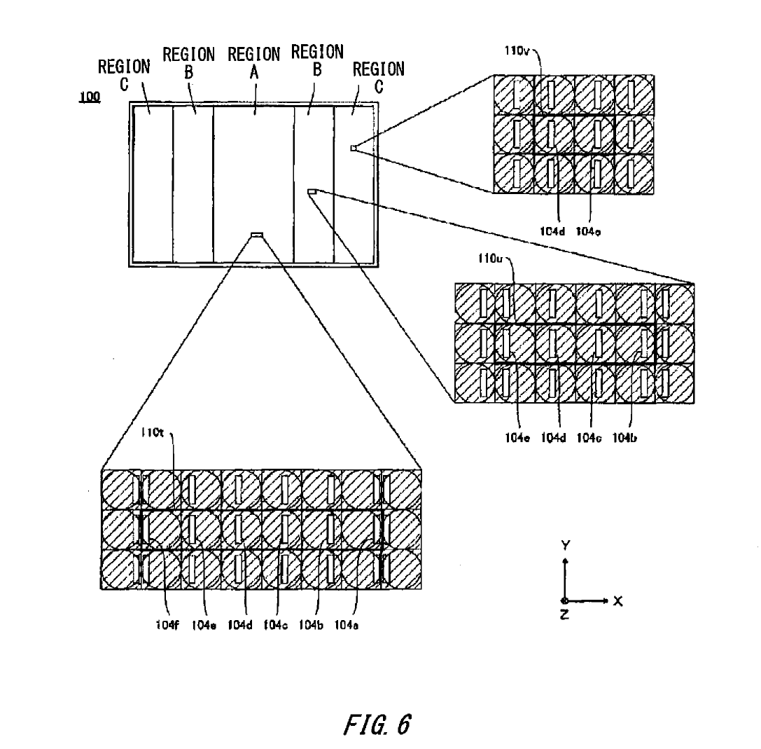

FIG. 6 is a diagram explaining repetition patterns 110 in respective regions of the image capturing element 100 according to the present embodiment. As shown in the drawing, a vertical-stripe-shaped region A of the image capturing element 100 that includes the center region is provided cyclically and continuously with repetition patterns 110t each consisting of six parallax pixels having the apertures 104a to 104f respectively.

Two vertical-stripe-shaped regions B adjoining the region A on both sides are provided cyclically and continuously with repetition patterns 110u each consisting of four parallax pixels having the apertures 104b to 104e respectively. Two vertical-stripe-shaped regions C adjoining the regions B on their peripheral sides are provided cyclically and continuously with repetition patterns 110v each consisting of two parallax pixels having the apertures 104c and 104d respectively.

When compared totally, the region in which partial regions, fluxes of light from which the apertures 104 included in a repetition pattern 110t arranged in the center region let through, are defined on the pupil is wider than the region in which partial regions, fluxes of light from which the apertures 104 included in a repetition pattern 110u arranged in a peripheral region let through, are defined on the pupil. Further, the region in which partial regions, fluxes of light from which the apertures 104 included in a repetition pattern 110u let through, are defined on the pupil is wider than the region in which partial regions, fluxes of light from which the apertures 104 included in a repetition pattern 110v arranged in a more outward peripheral region let through, are defined on the pupil.

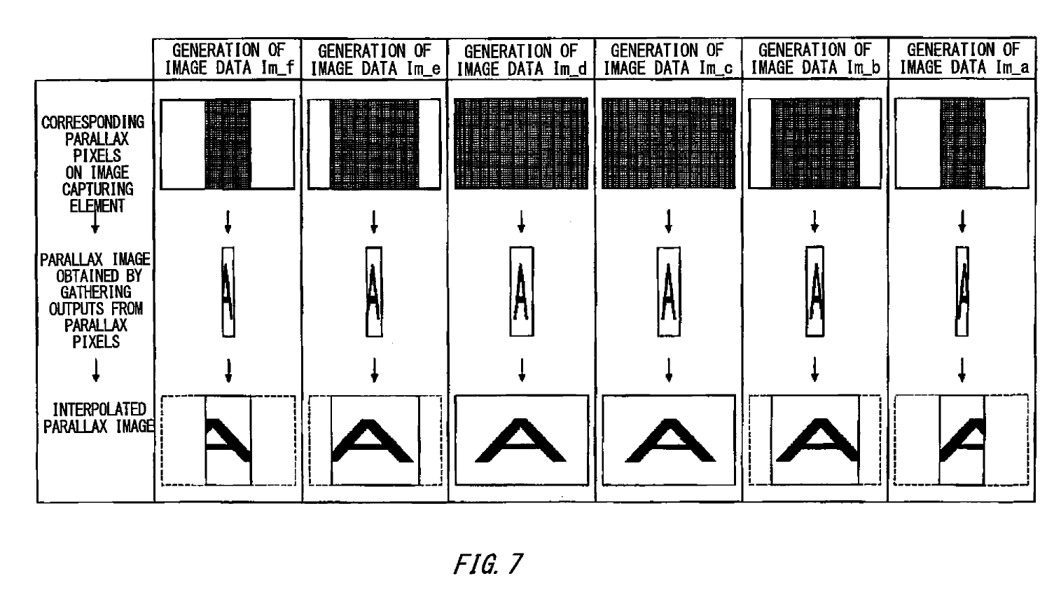

FIG. 7 is a concept diagram explaining a process for generating parallax images. The drawing shows in order from the column on the left of the sheet, how parallax image data Im_f to be generated by gathering the outputs from parallax pixels corresponding to the apertures 104f is generated, how parallax image data Im_e based on the outputs from the apertures 104e is generated, how parallax image data Im_d based on the outputs from the apertures 104d is generated, how parallax image data Im_c based on the outputs from the apertures 104c is generated, how parallax image data Im_b based on the outputs from the apertures 104b is generated, and how parallax image data Im_a based on the outputs from the apertures 104a is generated.

First, how parallax image data Im_f based on the outputs from the apertures 104f is generated will be explained. The region in which repetition patterns 110t including parallax pixels corresponding to the apertures 104f are arranged is the region A. Repetition patterns 110u and 110v arranged in the regions B and C do not include parallax pixels corresponding to the aperture 104f.

Repetition patterns 110t each constituted by a photoelectric converting element group consisting of six parallax pixels are arranged in the X axis direction in the region A. Therefore, the parallax pixels including the apertures 104f are located in the region A of the image capturing element 100 at every six pixels in the X axis direction, and continuously in the Y axis direction. These pixels receive fluxes of light from the object that are emitted from different minute regions respectively, as described above. When the outputs from these parallax pixels are arranged as gathered, a parallax image matching the region A is obtained.

However, because the pixels on the image capturing element 100 are square pixels, simply gathering them results in vertically-long image data as compared with the actual object image, since the number of pixels in the X axis direction is thinned to ⅙. Hence, interpolation to increase the number of pixels in the X axis direction to six times larger is applied to generate parallax image data Im_f which represents an image having the original aspect ratio. Because the parallax image data before interpolation is applied is an image thinned to ⅙ in the X axis direction, the resolution in the X axis direction is lower than the resolution in the Y axis direction. That is, the number of pieces of parallax image data to be generated and improvement of the resolution conflict.

Parallax image data Im_a based on the outputs from the apertures 104a is generated in the same manner as the parallax image data Im_f based on the outputs from the apertures 104f is generated. In this case, the parallax image data Im_a cannot include image data corresponding to the regions B and C.

Next, how parallax image data Im_e based on the outputs from the apertures 104e is generated will be explained. The regions in which repetition patterns 110t and 110u including parallax pixels corresponding to the apertures 104e are arranged are the regions A and B. A repetition pattern 110v arranged in the regions C do not include parallax pixels corresponding to the aperture 104e.

Repetition patterns 110t each constituted by a photoelectric converting element group consisting of six parallax pixels are arranged in the X axis direction in the region A. Therefore, the parallax pixels including the apertures 104f are located in the region A of the image capturing element 100 at every six pixels in the X axis direction, and continuously in the Y axis direction. These pixels receive fluxes of light from the object that are emitted from different minute regions respectively, as described above. When the outputs from these parallax pixels are arranged as gathered, a parallax image matching the region A is obtained.

Repetition patterns 110u each constituted by a photoelectric converting element group consisting of four parallax pixels are arranged in the X axis direction in the regions B. Therefore, the parallax pixels including the apertures 104e are located in the regions B of the image capturing element 100 at every four pixels in the X axis direction, and continuously in the Y axis direction. These pixels receive fluxes of light from the object that are emitted from different minute regions respectively, as described above. When the outputs from these parallax pixels are arranged as gathered, parallax images matching the regions B are obtained.

When the parallax image matching the region A and the parallax images matching the regions B are joined in a manner to maintain their relative positional relationship, a parallax image based on the parallax pixels corresponding to the apertures 104e can be generated. However, as described above, because the pixels on the image capturing element 100 according to the present embodiment are square pixels, simply gathering them results in vertically-long image data as compared with the actual object image, since the number of pixels in the X axis direction is thinned to ⅙ in the parallax image region corresponding to the region A and to ¼ in the parallax image regions corresponding to the regions B. Hence, interpolation to increase the number of pixels in the X axis direction to six times larger in the parallax image region corresponding to the region A and to four times larger in the parallax image regions corresponding to the regions B is applied to generate parallax image data Im_e which represents an image having the original aspect ratio.

Parallax image data Im_b based on the outputs from the apertures 104b is generated in the same manner as the parallax image data Im_e based on the outputs from the apertures 104e is generated. In this case, like the parallax image data Im_e, the parallax image data Im_b cannot include image data corresponding to the regions C.

Next, how parallax image data Im_d based on the outputs from the apertures 104d is generated will be explained. The regions in which repetition patterns 110t, 110u, and 110v including parallax pixels corresponding to the apertures 104d are arranged are the regions A, B and C. That is, all of the repetition patterns include parallax pixels corresponding to the apertures 104d.

Repetition patterns 110t each constituted by a photoelectric converting element group consisting of six parallax pixels are arranged in the X axis direction in the Region A. Therefore, the parallax pixels including the apertures 104d are located in the region A of the image capturing element 100 at every six pixels in the X axis direction, and continuously in the Y axis direction. These pixels receive fluxes of light from the object that are emitted from different minute regions respectively, as described above. When the outputs from these parallax pixels are arranged as gathered, a parallax image matching the region A is obtained.

Repetition patterns 110u each constituted by a photoelectric converting element group consisting of four parallax pixels are arranged in the X axis direction in the regions B. Therefore, the parallax pixels including the apertures 104d are located in the regions B of the image capturing element 100 at every four pixels in the X axis direction, and continuously in the Y axis direction. These pixels receive fluxes of light from the object that are emitted from different minute regions respectively, as described above. When the outputs from these parallax pixels are arranged as gathered, parallax images matching the regions B are obtained.

Repetition patterns 110v each constituted by a photoelectric converting element group consisting of two parallax pixels are arranged in the X axis direction in the regions C. Therefore, the parallax pixels including the apertures 104d are located in the regions C of the image capturing element 100 at every two pixels in the X axis direction and continuously in the Y axis direction. These pixels receive fluxes of light from the object that are emitted from different minute regions respectively, as described above. When the outputs from these parallax pixels are arranged as gathered, parallax images matching the regions C are obtained.

When the parallax images matching the regions A, B, and C in a manner to maintain there relative positional relationship, a parallax image based on the parallax pixels corresponding to the apertures 104d can be generated. However, as described above, because the pixels on the image capturing element 100 according to the present embodiment are square pixels, simply gathering them results in vertically-long image data as compared with the actual object image, since the number of pixels in the X axis direction is thinned to ⅙ in the parallax image region corresponding to the region A, to ¼ in the parallax image regions corresponding to the regions B, and to ½ in the parallax image regions corresponding to the regions C. Hence, interpolation to increase the number of pixels in the X axis direction to six times larger in the parallax image region corresponding to the region A, to four times larger in the parallax image regions corresponding to the regions B, and two times larger in the parallax image regions corresponding to the regions C is applied to generate parallax image data Im_d which represents an image having the original aspect ratio.

Parallax image data Im_c based on the outputs from the apertures 104c is generated in the same manner as the parallax image data Im_d based on the outputs from the apertures 104d is generated. In this case, like the parallax image data Im_d, the parallax image data Im_c can include image data corresponding to the regions A, B, and C.

In the way described above, six pieces of parallax image data that produce parallaxes in the X axis direction (horizontal direction) can be generated through image processing of the image processing section 205. As described above, these parallax images may likely have different angles of view due to the positions on the image capturing element 100 of the parallax pixels from which outputs have been gathered. Hence, when these pieces of parallax image data are reproduced on a 3D display apparatus, the viewer will perceive the center portion of the object as a 3D image from six viewpoints, portions on both sides of the center portion as 3D images from four viewpoints, and more outward peripheral portions as 3D images from two viewpoints.

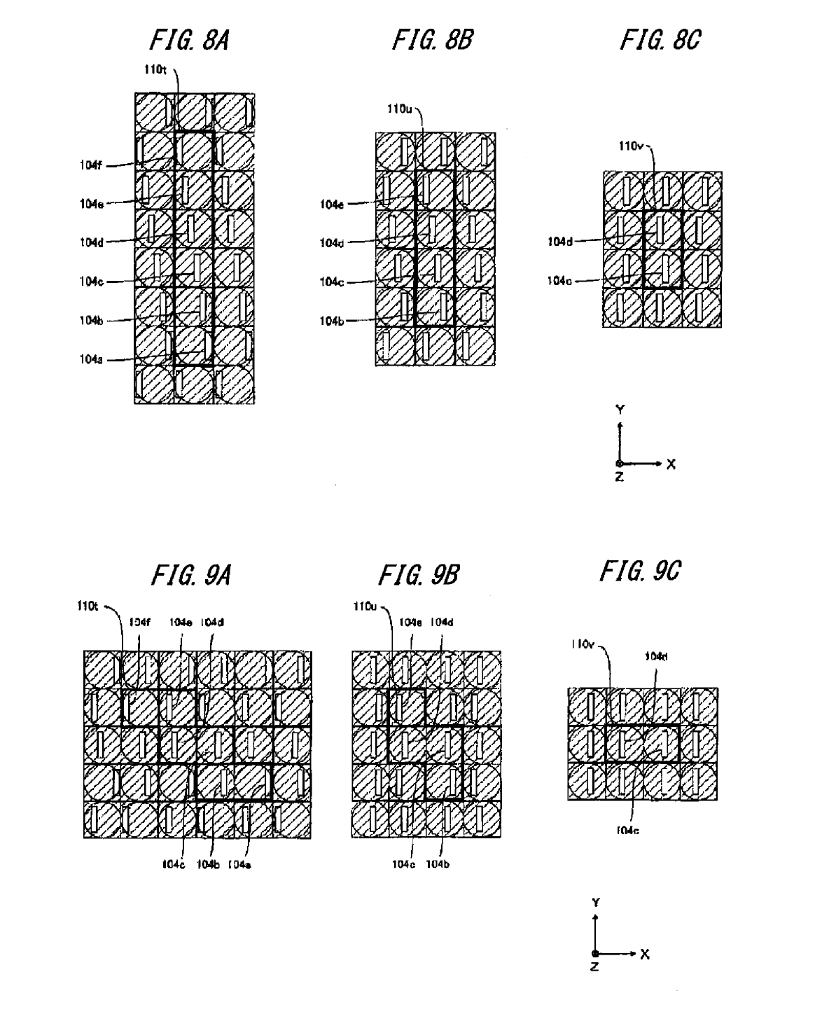

In the above example, the case in which the repetition patterns 110 are arranged cyclically in the X axis direction has been explained, but the arrangement of the repetition patterns 110 is not limited to this. FIG. 8 is a diagram showing another example of the repetition patterns. In this another example, the repetition patterns 110 are arranged cyclically in the Y axis direction.

As in the sectioning of the image capturing element 100 shown in FIG. 6, the region A of the image capturing element 100 is provided cyclically and continuously with repetition patterns 110t each consisting of six parallax pixels including the apertures 104a to 104f respectively as shown in FIG. 8A. In each such repetition pattern 110t, the apertures 104 are staggered gradually such that the parallax pixels on the more +Y side include apertures 104 on the more −X side while the parallax pixels on the more −Y side include apertures 104 on the more +X side. Repetition patterns 110 having this arrangement can also generate parallax images that produce parallaxes in the X axis direction.

The regions B are provided cyclically and continuously with repetition patterns 110u each consisting of four parallax pixels including the apertures 104b to 104e respectively, as shown in FIG. 5B. The regions C are provided cyclically and continuously with repetition patterns 110v each consisting of two parallax pixels including the apertures 104c and 104d respectively, as shown in FIG. 8C.

Six pieces of parallax image data that produce parallaxes in the horizontal direction can also be generated from such repetition patterns 110 through image processing by the image processing section 205. In this case, these repetition patterns can be said to be repetition patterns that maintain the resolution in the X axis direction at the cost of the resolution in the Y axis direction, as compared with the repetition patterns 110 shown in FIG. 6.

FIG. 9 are diagrams showing yet another example of repetition patterns. In this another example, repetition patterns 110 consisting of pixels adjoining each other in a diagonal direction are arranged cyclically.

As in the sectioning of the image capturing element 100 shown in FIG. 6, the region A of the image capturing element 100 is provided cyclically and continuously with repetition patterns 110t each consisting of six parallax pixels including the apertures 104a to 104f respectively, as shown in FIG. 9A. In each such repetition pattern 110t, the apertures are staggered gradually such that the parallax pixels on the more −X side and the more +Y side (on the upper left end in the drawing) include apertures on the more −X side while the parallax pixels on the more +X side and the more −Y side (on the lower right end in the drawing) include apertures on the more +X side. Repetition patterns 110 having this arrangement can also generate parallax images that produce parallaxes in the X axis direction.

The regions B are provided cyclically and continuously with repetition patterns 110u each consisting of four parallax pixels including the apertures 104b to 104e respectively, as shown in FIG. 9B. The regions C are provided cyclically and continuously with repetition patterns 110v each consisting of two parallax pixels including the apertures 104c and 104d respectively, as shown in FIG. 9C.

Six pieces of parallax image data that produce parallaxes in the X axis direction can also be generated from such repetition patterns 110 through image processing by the image processing section 205. In this case, when compared with the repetition patterns 110 shown in FIG. 6, these repetition patterns can be said to be repetition patterns that generate many parallax images at small reduction in the resolution in the Y axis direction and in the resolution in the X axis direction.

When compared, the repetition patterns 110 shown in FIGS. 6, 8, and 9 are different in the resolution of which of the Y axis direction and the X axis direction is to reduce from the resolution of a non-parallax image that is output from all pixels, when generating parallax images from six viewpoints. In comparison of the repetition patterns 110t in the region A, the repetition pattern shown in FIG. 6 reduces the resolution in the X axis direction to ⅙, the repetition pattern shown in FIG. 8A reduces the resolution in the Y axis direction to ⅙, and the repetition pattern shown in FIG. 9A reduces the resolution in the Y axis direction to ⅓ and the resolution in the X axis direction to ½. In any case, each pattern includes all of the apertures 104a to 104f one by one in correspondence with the respective pixels included, and these apertures receive fluxes of light from the object through the corresponding partial regions Pa to Pf respectively. Therefore, any repetition pattern 110 produces an equal or similar amount of parallax.

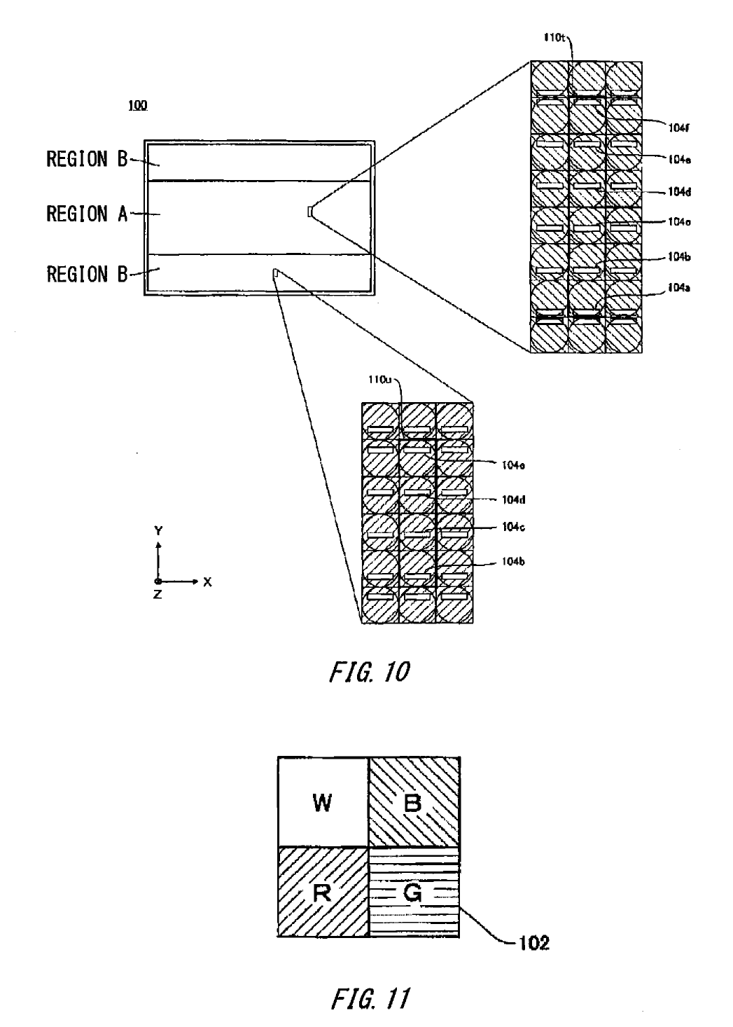

In the above example, the case of generating parallax images that produce parallaxes in the horizontal direction (X axis direction) has been explained, but needless to say, it is possible to generate parallax images that produce parallaxes in the vertical direction (Y axis direction) or to generate parallax images that produce parallaxes two-dimensionally in the horizontal and vertical directions. FIG. 10 is a diagram explaining repetition patterns 110 in respective regions of an image capturing element for outputting vertical parallax images that produce parallaxes in the vertical direction.

As shown in the drawing, a horizontal-stripe-shaped region A of the image capturing element 100 that includes the center region is provided cyclically and continuously with repetition patterns 110t each consisting of six parallax pixels having the apertures 104a to 104f respectively. In the shown example, there are six kinds of aperture masks 103 in which the positions of the apertures 104 with respect to the corresponding pixels are staggered in the Y axis direction. On the whole, the image capturing element 100 is provided two-dimensionally and cyclically with photoelectric converting element groups each including six parallax pixels having the apertures 104a to 104f that are gradually staggered from the +Y side (the upper side of the drawing) to the −Y side (the lower side of the drawing). That is, it can be said that the image capturing element 100 is composed being filled with repetition patterns 110 which are arranged cyclically and continuously and each include one photoelectric converting element group. In the shown example, the shape of the apertures 104 is a horizontally-long rectangle, but is not limited to this. The apertures may have any shape, as long as the apertures are staggered with respect to the center of the corresponding pixels to have a line of sight that is directed to a specific partial region of the pupil.

Two horizontal-stripe-shaped regions B adjoining the region A on both sides are each provided cyclically and continuously with repetition patterns 110u each consisting of four parallax pixels having the apertures 104b to 104e respectively.

When compared totally, the region in which partial regions, fluxes of light from which the apertures 104 included in a repetition pattern 110t arranged in the center region let through, are defined on the pupil is wider than the region in which partial regions, fluxes of light from which the apertures 104 included in a repetition pattern 110u arranged in the peripheral region let through, are defined on the pupil.

When image processing similar to the image processing explained in FIG. 7 is applied to the image data output from this image capturing element 100, six pieces of parallax image data that produce parallaxes in the vertical direction can be generated. As described above, these parallax images may likely have different angles of view due to the positions on the image capturing element 100 of the parallax pixels from which outputs have been gathered. Hence, when these pieces of parallax image data are reproduced on a 3D display apparatus, the viewer will perceive the center portion of the object as a 3D image from six viewpoints, and portions on both sides of the center portion as 3D images from four viewpoints.

Next, the color filters 102 and parallax images will be explained. FIG. 11 is a diagram explaining the arrangement of the color filters. The color filters shown in the drawing are of a modified Bayer arrangement which is obtained by maintaining the lower right pixel of the four pixels of a so-called Bayer arrangement as a G pixel to which a green filter is allocated, while changing the upper left pixel to a W pixel to which no color filter is allocated. The upper right pixel is allocated as a B pixel with a blue filter provided and the lower left pixel is allocated as an R pixel with a red filter provided, which is the same as in the Bayer arrangement. The W pixel may be provided with a non-color transparent filter in order to allow substantially all wavelength bands of the visible light to transmit.

Regardless of what type of color filter arrangement such as a Bayer arrangement, the color filter arrangement shown in FIG. 11, etc. is to be employed, an enormous number of combination patterns can be set depending on to which color pixels and at what cycle parallax pixels and non-parallax pixels are to be allocated. When outputs from non-parallax pixels are gathered, captured image data that will produce no parallax like captured image data resulting from normal image capturing can be generated. Therefore, by increasing the ratio of non-parallax pixels, it is possible to output a 2D image having a high resolution. In this case, because the ratio of parallax pixels is lowered, the quality of 3D images composed of a plurality of parallax images is deteriorated. Conversely, when the ratio of parallax pixels is increased, the quality of 3D images is improved while a 2D image having a low resolution is output.

In this trade-off relationship, combination patterns having various characteristics will be set depending on which pixels are to be allocated as parallax pixels or non-parallax pixels. For example, 2D image data with a high resolution is obtained when many pixels are allocated as non-parallax pixels, and 2D image data with a high quality with little color gap is obtained when all of the R, G, and B pixels are equally allocated as non-parallax pixels. When 2D image data is generated based also on outputs from parallax pixels, the object image, which includes distortion, is corrected by referring to outputs from surrounding pixels. Therefore, it is possible to generate a 2D image even if all of, for example, R pixels are allocated as parallax pixels, but the quality of the generated 2D image is inevitably low.

On the other hand, 3D image data with a high resolution is obtained when many pixels are allocated as parallax pixels, and color image data that is 3D but nevertheless has a high quality with fine color reproduction is generated when all of the R, G, and B pixels are equally allocated as parallax pixels. When 3D image data is generated based also on outputs from non-parallax pixels, outputs from surrounding parallax pixels are referred to in order to generate a distorted object image from the object image having no parallax. Therefore, it is possible to generate a color 3D image even if all of, for example, R pixels are allocated as non-parallax pixels, but the quality of the generated 3D image is likewise low.

When a color filter arrangement including W pixels is employed, the accuracy of color information to be output by the image capturing element is slightly deteriorated, but the amount of light to be received is greater when W pixels are provided than when color filters are provided, which enables luminance information with high accuracy to be output. It is also possible to generate a monochrome image by gathering outputs from W pixels.

A color filter arrangement including W pixels has many more variations for combination patterns between parallax pixels and non-parallax pixels. For example, as long as it is an image that is output from W pixels, even an image that was captured in a relatively dark environment has a higher object image contrast than an image that is output from color pixels. Hence, when W pixels are allocated as parallax pixels, a highly accurate operation result can be expected from a matching process that is performed between a plurality of parallax images. A matching process is performed as a part of a process for obtaining distance information for an object image that is captured into the image data. Therefore, the combination pattern between parallax pixels and non-parallax pixels is set by taking into consideration the influences to the resolution of a 2D image and the quality of parallax images, as well as advantages or disadvantages to other information to be extracted.

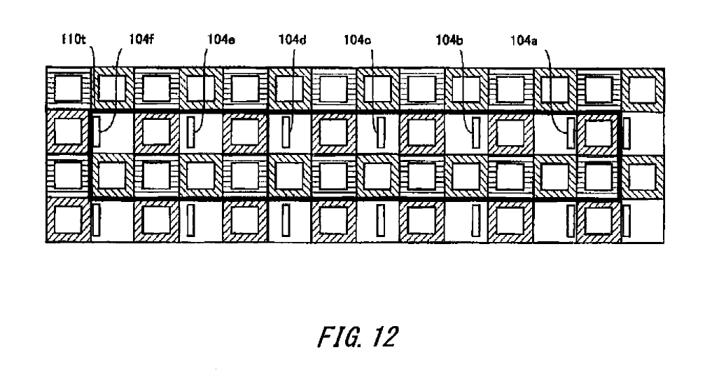

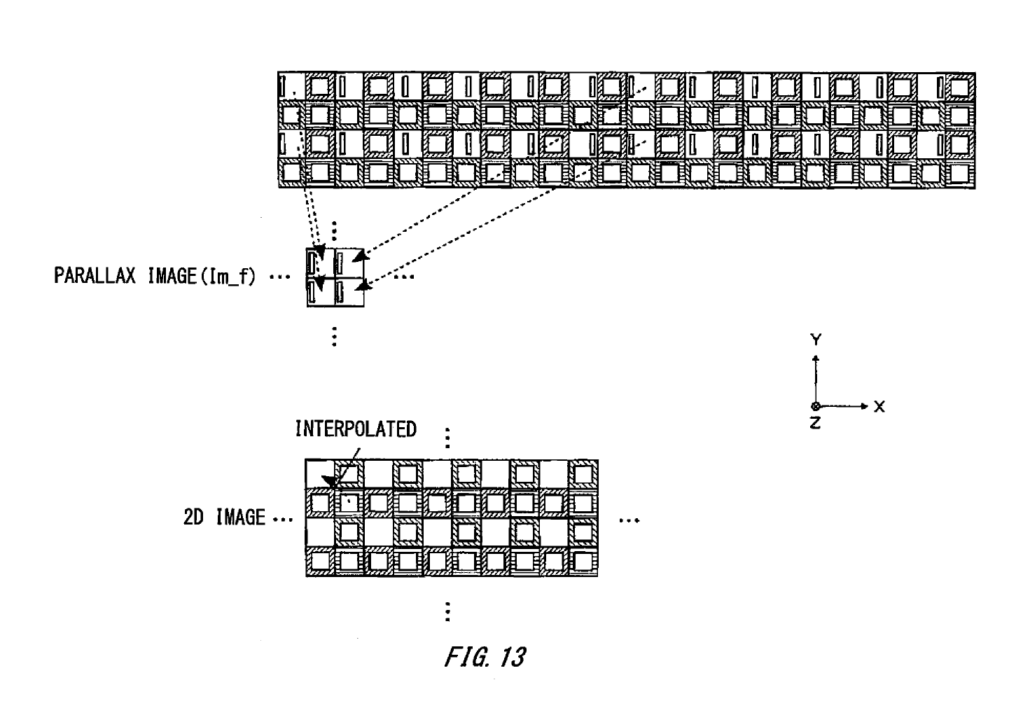

FIG. 12 is a diagram showing a relationship between a color filter arrangement and parallax pixels. Particularly, FIG. 12 shows an example of an arrangement of W pixels and parallax pixels for a case when the color filter arrangement of FIG. 11 is employed. In the shown example, each combination pattern includes twenty-four pixels including X-axially arranged six groups of four pixels that are disposed in the color filter arrangement of FIG. 11. Parallax pixels including the apertures 104f, 104e, . . . , 104a are allocated to the W pixels included in the combination pattern from the leftmost W pixel to the rightmost W pixel. The image capturing element 100 having this arrangement outputs a parallax image as a monochrome image and a 2D image as a color image.

When the combination pattern of FIG. 12 is employed in, for example, in the region A of FIG. 6, the combination pattern to be employed in the regions B is one that includes sixteen pixels including X-axially arranged four groups of four pixels that are disposed in the color filter arrangement of FIG. 11. In this case, parallax pixels including the apertures 104e, . . . 104b are allocated to the W pixels included in the combination pattern from the leftmost W pixel to the rightmost W pixel. Likewise, the combination pattern to be employed in the regions C is one that includes eight pixels including X-axially arranged two groups of four pixels that are disposed in the color filter arrangement of FIG. 11. In this case, a parallax pixel including the aperture 104d is allocated to the left-hand W pixel and a parallax pixel including the aperture 104c is allocated to the right-hand W pixel.

Here, generation of a parallax pixel as a monochrome image and generation of a 2D image as a color image will be explained.

FIG. 13 is a concept diagram showing a process of generating a parallax image and a 2D image. As shown in the drawing, when outputs from parallax pixels including the apertures 104f are gathered in a manner to maintain the positional relationship of these parallax pixels on the image capturing image 100, Im_f image data is generated. Because one repetition pattern 110 includes one parallax pixel that includes the aperture 104f, the parallax pixels including the apertures 104f that constitute the Im_f image data are gathered from different repetition patterns 110 respectively. That is, because the respective outputs that are gathered are the photoelectrically-converted results of fluxes of light emitted from different minute regions of the object, the Im_f image data is one piece of parallax image data in which the object from a specific viewpoint (a viewpoint f) is captured. Since these parallax pixels are allocated as W pixels, the Im_f image data includes no color information but is generated as a monochrome image.

Likewise, when outputs from parallax pixels including the apertures 104e to 104a are gathered respectively in a manner to maintain the positional relationship of the parallax pixels on the image capturing image 100, Im_e image data to Im_a image data are generated respectively.

When outputs from non-parallax pixels are gathered in a manner to maintain the positional relationship of these pixels on the image capturing element 100, 2D image data is generated. In this case, because the W pixels are parallax pixels, the outputs from the Bayer arrangement which consists only of non-parallax pixels do not include the outputs from the upper left pixels. Hence, for example, the values of the outputs from the G pixels are substituted for the values of these missing outputs. That is, interpolation is applied based on the outputs from the G pixels. Interpolation applied in this way allows 2D image data to be generated by employing image processing to be originally applied for the outputs from a Bayer arrangement.

The above image processing is performed by the image processing section 205. The image processing section 205 receives image signals output from the image capturing element 100 through the control section 201, and generates parallax image data and 2D image data dividedly based on outputs from each of the respective kinds of pixels as described above.

In the embodiment described above, the image capturing element 100 has been explained as being composed filled cyclically and continuously with repetition patterns 110 each constituted by a photoelectric converting element group. However, since it is only necessary for the respective parallax pixels to capture discrete minute regions of the object respectively and output parallax images, it is allowed for non-parallax pixels to be provided continuously between cyclic repetition patterns 110. That is, parallax images can be output even if the repetition patterns 110 including parallax pixels are discontinuous, as long as they are cyclic.

In the embodiment described above, the image capturing element 100 of, for example, FIG. 6 is sectioned into three kinds of regions, namely regions A, B, and C, but needs not necessarily be sectioned into this number of kinds of regions. The number of kinds of apertures 104 in each region is also not limited to six kinds, four kinds, and two kinds. How to section the image capturing element 100 and how to configure the repetition patterns to be arranged in the regions resulting from the division are determined based on the image capturing lens 20 and vignetting due to the lens barrel that supports the image capturing lens.

That is, sectioning and repetition patterns are determined so as not to produce parallax pixels that cannot receive fluxes of light from the object through partial regions defined on the pupil due to vignetting. Therefore, the boundaries between the regions need not be straight lines as shown in FIG. 6 and FIG. 10 that are parallel with the long side or the short side of the image capturing element, but may be curves that conform to the vignetting.

Because vignetting is more noticeable when the focal length is set to a wider angle and the lens diaphragm is opened more largely, it is preferable to determine sectioning and repetition patterns under conditions that induce noticeable vignetting. Particularly, when the digital camera 10 is a lens-replaceable camera, it is preferable to determine these settings in total consideration of attachable image capturing lenses.

In the embodiment described above, for example, the repetition patterns shown in FIG. 6 include six parallax pixels in the region A, and four parallax pixels in the adjoining regions B with the pixels on both ends of the six pixels of the region A omitted. However, as can be understood from FIG. 5, in the region B adjoining the region A on the right-hand side (region Br), no fluxes of light from the object reach the parallax pixels including the apertures 104a, but fluxes of light from the object reach the parallax pixels including the apertures 104f. Therefore, the region Br may be provided with repetition patterns each consisting of five parallax pixels including the apertures 104b to 104f respectively. In this case, likewise, the region B adjoining the region A on the left-hand side (region Bl) may be provided with repetition patterns each consisting of five parallax pixels including the apertures 104a to 104e.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

### EXPLANATION OF REFERENCE NUMERALS

10 digital camera
20 image capturing lens
21 optical lens
30, 31 object
100 image capturing element
101 micro-lens
102 color filter
103 aperture mask
104 aperture
105 interconnection layer
106 interconnection line
107 aperture
108 photoelectric converting element
109 substrate
110 repetition pattern
120 image capturing element
121 screen filter
122 color filter section
123 aperture mask section
201 control section
202 A/D converter circuit
203 memory
204 driving section
205 image processing section
206 calculation section
207 memory card I/F
208 operation section
209 display section
210 LCD driving circuit
220 memory card

What is claimed is:

1. An image capturing element, comprising:
photoelectric converting element groups arranged two-dimensionally and cyclically and each including a plurality of photoelectric converting elements that photoelectrically convert incident light to electric signals, wherein
apertures of aperture masks provided in correspondence with the plurality of photoelectric converting elements included in each of the photoelectric converting element groups are positioned so as to let through fluxes of light from different partial regions included in a cross-sectional region of the incident light, and so as to be at different positions from each other relative to each photoelectric converting element in the photoelectric converting element groups, and
the number of photoelectric converting elements included in each of the photoelectric converting element groups is smaller in such photoelectric converting element groups that are arranged in a peripheral region than in such photoelectric converting element groups that are arranged in a center region.

2. The image capturing element according to claim 1, wherein when compared in a whole photoelectric converting element group unit, a region in the cross-sectional region in which there are defined the partial regions, fluxes of light from which the apertures of the aperture masks provided in correspondence with the plurality of photoelectric converting elements included in each of the photoelectric converting element groups arranged in the center region let through is wider than a region in the cross-sectional region in which there are defined the partial regions, fluxes of light from which the apertures of the aperture masks provided in correspondence with the plurality of photoelectric converting elements included in each of the photoelectric converting element groups arranged in the peripheral region let through.

3. The image capturing element according to claim 2, wherein the cross-sectional region is determined based on vignetting of an image capturing lens including an optical system for allowing the incident light to transmit.

4. The image capturing element according to claim 1, wherein a direction in which the center region is joined to the peripheral region is parallel with a direction in which the apertures of the aperture masks are staggered.

5. The image capturing element according to claim 1, wherein when an object is at an in-focus position, the plurality of photoelectric converting elements included in each of the photoelectric converting element groups receive fluxes of light that are emitted from one minute region of the object.

6. The image capturing element according to claim 1, wherein photoelectric converting elements that are not provided with the aperture masks or that are provided with aperture masks that allow passage of all fluxes of effective light of the incident light are arranged two-dimensionally and cyclically adjoining the plurality of photoelectric converting elements included in each of the photoelectric converting element groups.
